(19) United States
(12) Patent Application Publication
(10) Pub. No.: US 2010/0164816 A1
(43) Pub. Date: Jul. 1, 2010

(54) ANTENNA STRUCTURE OF RECTANGULAR LOOP ANTENNA

(75) Inventors: Hiroshi Kuribayashi, Utsunomiya-shi, (JP); Satoru Komatsu, Utsunomiya-shi, (JP); Hideaki Oshima, Narita-shi (JP); Hiroshi Iijima, Moriya-shi (JP)

Correspondence Address: ARENT FOX LLP, 1050 CONNECTICUT AVENUE, N.W., SUITE 400, WASHINGTON, DC, 20036, US

(73) Assignees: HONDA MOTOR CO., LTD., Tokyo (JP); NIPPON SHEET GLASS COMPANY, LIMITED, Minato-ku, Tokyo (JP)

(21) Appl. No.: 12/593,223

(22) PCT Filed: Mar. 27, 2008
(86) PCT No.: PCT/JP2008/055883

§ 371 Date: Sep. 25, 2009

(30) Foreign Application Priority Data
Mar. 27, 2007 (JP) 2007-082171

(51) Int. Cl. H01Q 1/32; H01Q 7/00

(52) U.S. Cl. 343/713; 343/866

(57) ABSTRACT

An antenna structure of a rectangular loop antenna that is provided on a window glass of a vehicle, includes: another loop portion that is provided inside a rectangular loop portion of the rectangular loop antenna and has a path partially shared with the rectangular loop portion; and a bypass unit that connects the path of the another loop portion and the path of the rectangular loop portion which is not shared with the path of the another loop portion.

### BACKGROUND OF THE INVENTION

1. Field of the Invention

The present invention relates to the antenna structure of a rectangular loop antenna.

Priority is claimed on Japanese Patent Application No. 2007-082171, the content of which is incorporated herein by reference.

2. Description of Related Art

A dipole linear antenna provided on a window glass of a vehicle has been known. The linear antenna is provided for wireless communication in an in-vehicle apparatus, such as a VICS or a mobile phone, and transmits or receives electric waves to a station provided outside the vehicle. Since the linear antenna has a simple dipole structure, it has a low manufacturing cost. However, since the linear antenna has a narrow frequency band for transmission and reception, the field of usage thereof is limited. Therefore, in order to widen the field of usage of the linear antenna, a loop antenna having a large width has been proposed in which the width of a linear portion is increased and the left and right linear portions having a large width are electrically connected to each other at the upper end.

In addition, as disclosed in Japanese Unexamined Patent Application, First Publication No. 2005-204194, an antenna has been proposed which combines a rectangular loop antenna and another type of antenna, for example, a folded dipole antenna to widen the frequency band.

However, since the antenna has a linear portion with a large width, it is not appropriate to provide the antenna on the front glass or the rear glass of the vehicle.

In the structure in which the rectangular loop antenna is combined with another type of antenna, when the frequency band is widened, it is necessary to provide multiple loops. Therefore, the outer dimensions of the structure are increased in proportion to the number of multiple structures. As a result, the outward appearance of the antenna is likely to be adversely affected.

It has generally been known that a voltage standing wave ratio (hereinafter, referred to as a VSWR) is preferably less than or equal to 2 as the performance of the antenna for mobile communication. When the VSWR is reduced, transmission/reception efficiency is improved. On the other hand, when the VSWR is increased, the transmission/reception efficiency is lowered. In particular, in many cases, an antenna for mobile communication, such as an in-vehicle antenna, is provided at a height lower than 10 nm from the ground, where the transmission and reception environment is severe. Therefore, the VSWR needs to be less than or equal to 2 in order to smoothly perform mobile communication.

### SUMMARY OF THE INVENTION

An object of the invention is to provide the antenna structure of a rectangular loop antenna capable of widening a frequency band with high reception efficiency without adversely affecting the outward appearance.

In order to solve the above problem to achieve such an object, the present invention suggests the following means.

(1) An antenna structure of a rectangular loop antenna that is provided on a window glass of a vehicle includes: a loop portion that is provided inside a rectangular loop portion of the rectangular loop antenna and has a path partially shared with the rectangular loop antenna; and a bypass unit that connects the path of the loop portion and the path of the rectangular loop portion which is not shared with the path of the loop portion.

(2) In the antenna structure of a rectangular loop antenna according to (1), at least two pairs of the bypass units may be provided.

(3) In the antenna structure of a rectangular loop antenna according to (1), the rectangular loop portion may have a feed portion on a loop line thereof.

(4) In the antenna structure of a rectangular loop antenna according to (1), the rectangular loop portion may have an electrostatic coupling portion electrostatically coupled to a portion of a loop line thereof.

(5) In the antenna structure of a rectangular loop antenna according to (1), a bypass unit that connects portions of the path of the loop portion that are not shared with the path of the rectangular loop portion may be provided inside the loop portion.

(6) An antenna structure of a rectangular loop antenna that is provided on a window glass of a vehicle includes: a first line that has a feed portion at the center thereof; a second line that is opposite to the first line; a rectangular loop portion that is formed by third and fourth lines connecting the ends of the first and second lines; fifth and sixth lines that are provided inside the rectangular loop portion and are parallel to the third and fourth lines connected to the first and second lines, respectively; a seventh line that connects the feed portion or the first line in the vicinity of the feed portion and the fifth line; and an eighth line that connects the first line and the sixth line.

(7) In the antenna structure of a rectangular loop antenna according to (6), the antenna structure may further include a ninth line that connects the third line and the fifth line; and a tenth line that connects the fourth line and the sixth line.

(8) In the antenna structure of a rectangular loop antenna according to (6), the antenna structure may further include an eleventh line that is parallel to the second line and connects the fifth line and the sixth line.

According to the first aspect of the invention, the bypass unit that connects the rectangular loop portion and another loop portion formed inside the rectangular loop portion is provided between the paths of the rectangular loop portion and another loop portion that are not shared with each other. Therefore, it is possible to form three or more paths having different frequency characteristics using the bypass unit and widen a frequency band having a VSWR of 2 or less, without increasing the outer dimensions of the antenna or providing three or more multiple loops which could adversely affect the outward appearance.

According to the second aspect of the invention, it is possible to increase the number of paths, as compared to the structure in which a pair of bypass units is provided, and widen the frequency band, in addition to the effects of the first aspect.

According to the third aspect of the invention, it is possible to solve the following problems and improve and stabilize the antenna performance, in addition to the effects of the first aspect: the efficiency of the antenna is lowered due to impedance mismatching between the antenna and a coaxial cable; an electromagnetic wave radiated by the coaxial cable causes the power loss of the antenna or the distortion of the directivity of the antenna; the shielding performance of the coaxial cable is lowered and the antenna is likely to be affected by ambient noise; antenna characteristics vary due to the shaking of the coaxial cable caused by vibration or a difference in the layout of the coaxial cable; and the antenna performance is lowered due to the damage of the coaxial cable or the lowering of the noise figure caused by the damage of the coaxial cable.

According to the fourth aspect of the invention, loop lines can be arranged close to each other so as to obtain electrostatic coupling therebetween, thereby forming a rectangular loop portion, in addition to the effects of the first aspect.

According to the fifth aspect of the invention, it is possible to widen the frequency band having a VSWR of 2 or less and improve the VSWR characteristics, as compared to the structure in which the upper parallel line is not provided, in addition to the effects of the first aspect. In this way, it is possible to ensure good antenna characteristics over the entire frequency band.

According to the sixth aspect of the invention, the third line and the fourth line are provided inside the rectangular loop portion, and two lines, that is, the seventh and eighth lines that connect the third and fourth lines and the feed portion or the first line in the vicinity of the feed portion are provided. In this way, it is possible to form paths having different frequency characteristics using the bypass unit and widen the frequency band having a VSWR of 2 or less, without increasing the outer dimensions of the rectangular loop antenna or providing three or more multiple loops which could adversely affect the outward appearance of the antenna.

According to the seventh aspect of the invention, the ninth line is provided between the third line and the fifth line, and the tenth line is provided between the fourth line and the sixth line. Therefor; it is possible to increase the number of paths and widen the frequency band, in addition to the effects of the sixth aspect.

According to the eighth aspect of the invention, since the eleventh line is provided, it is possible to widen the frequency band having a VSWR of 2 or less and improve the VSWR characteristics, as compared to the structure in which the eleventh line is not provided, in addition to the effects of the sixth aspect. In this way, it is possible to ensure good antenna characteristics over the entire frequency band.

### BRIEF DESCRIPTION OF THE DRAWINGS

FIG. 1A is a perspective view illustrating a vehicle to which an in-vehicle antenna according to a first embodiment of the invention is mounted.

FIG. 1B is a perspective view illustrating the vehicle to which the in-vehicle antenna according to the first embodiment is mounted.

FIG. 2 is a front view illustrating the in-vehicle antenna according to the first embodiment.

FIG. 3A is a front view illustrating the in-vehicle antenna according to the first embodiment, and shows a first closed circuit L1.

FIG. 3B is a front view illustrating the in-vehicle antenna according to the first embodiment, and shows a second closed circuit L2.

FIG. 3C is a front view illustrating the in-vehicle antenna according to the first embodiment, and shows a third closed circuit L3.

FIG. 3D is a front view illustrating the in-vehicle antenna according to the first embodiment, and shows a fourth closed circuit L4.

FIG. 4A is a front view illustrating the in-vehicle antenna according to the first embodiment, and shows a fifth closed circuit L5.

FIG. 4B is a front view illustrating the in-vehicle antenna according to the first embodiment, and shows a sixth closed circuit L6.

FIG. 5 is a graph illustrating the relationship between the frequency and VSWTR of the in-vehicle antenna according to the first embodiment.

FIG. 6 is a front view illustrating a modification of the in-vehicle antenna according to the first embodiment, and corresponds to FIG. 2.

FIG. 7 is a diagram schematically illustrating a dipole antenna.

FIG. 8 is a diagram schematically illustrating the structure of a modification of the dipole antenna shown in FIG. 7.

FIG. 9 is a diagram schematically illustrating the structure of a modification of the antenna shown in FIG. 8.

FIG. 10 is a diagram schematically illustrating the structure of a modification of the antenna shown in FIG. 9.

FIG. 11 is a graph illustrating the input impedance characteristics of the dipole antenna shown in FIG. 7.

FIG. 12 is a graph illustrating the input impedance characteristics of the antenna shown in FIG. 8.

FIG. 13 is a graph illustrating the input impedance characteristics of the antenna shown in FIG. 9.

FIG. 14 is a graph illustrating the input impedance characteristics of the antenna shown FIG. 10.

FIG. 15 is a graph illustrating the VSWR characteristics of the antennas shown in FIGS. 7 to 10.

FIG. 16 is a front view illustrating an in-vehicle antenna according to a second embodiment of the invention.

FIG. 17 is a diagram schematically illustrating the in-vehicle antenna according to the second embodiment mounted to a front glass.

FIG. 18 is a reference diagram illustrating connection between the in-vehicle antenna and an amplifier module by a coaxial cable.

FIG. 19 is a front view illustrating an in-vehicle antenna according to a third embodiment of the invention.

FIG. 20 is a graph illustrating the VSWR characteristics of the in-vehicle antenna shown in FIG. 19.

### DETAILED DESCRIPTION OF THE INVENTION

Hereinafter, exemplary embodiments of the invention will be described. Firstly, the background of the embodiments will be described.

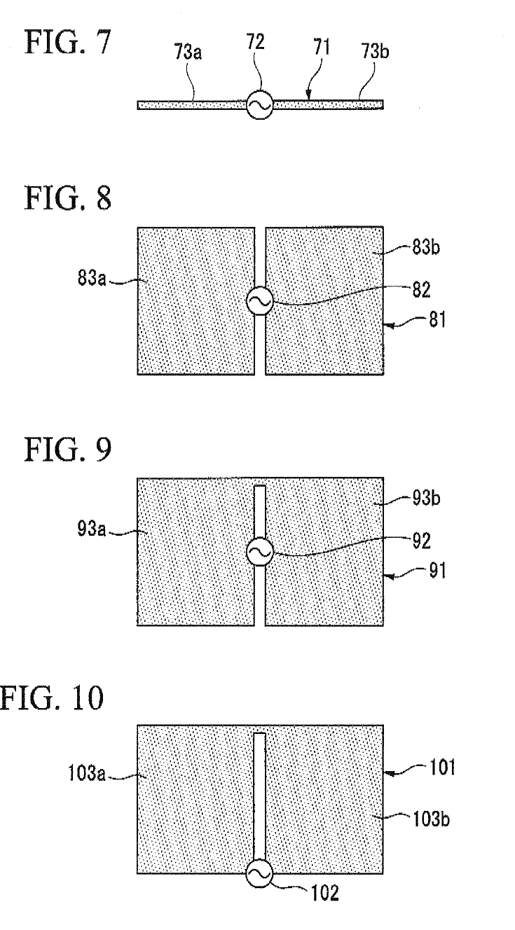

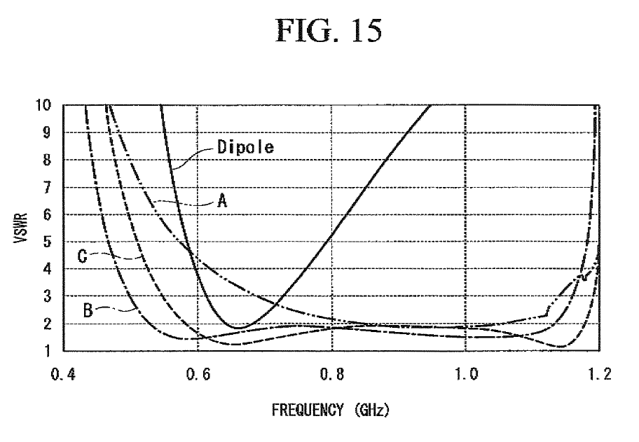

FIG. 7 shows a dipole antenna 71 that is used for calibration when the antenna is evaluated. The dipole antenna 71 includes a feed portion 72 provided at the center thereof and rod-shaped (linear) conductors 73a and 73b extending from the feed portion 72 to the left and right sides. FIG. 11 shows the frequency (horizontal axis) characteristics of the input impedance (vertical axis) of the dipole antenna 71. The input impedance includes a real number part (Re) and an imaginary number part (Im), and the real number part corresponds to the radiation resistance of the antenna. As shown in FIG. 15, the dipole antenna 71 has a very narrow frequency band having a VSWR (voltage standing wave ratio represented by a solid line in FIG. 15) of 2 or less. Therefore, in order to cover a wide band, a plurality of dipole antennas 71 are provided and the dipole antennas 71 are appropriately switched, which results in an increase in the number of parts.

Therefore, in order to widen a frequency band using one antenna without increasing the number of parts, for example, as shown in FIG. 8, an antenna (type A) 81 is provided which includes a feed portion 82 and conductors 83a and 83b that are obtained by increasing the widths of the conductors 73a and 73b of the dipole antenna 71 and extend to the left and right sides of the feed portion 82. As shown in FIG. 15, in the antenna (type A) 81, a frequency band having a VSWR (which is represented by a two-dot chain line in FIG. 15) of 2 or less is slightly wider than that of the dipole antenna 71. FIG. 12 shows the frequency (horizontal axis) characteristics of the input impedance (vertical axis) of the antenna (type A).

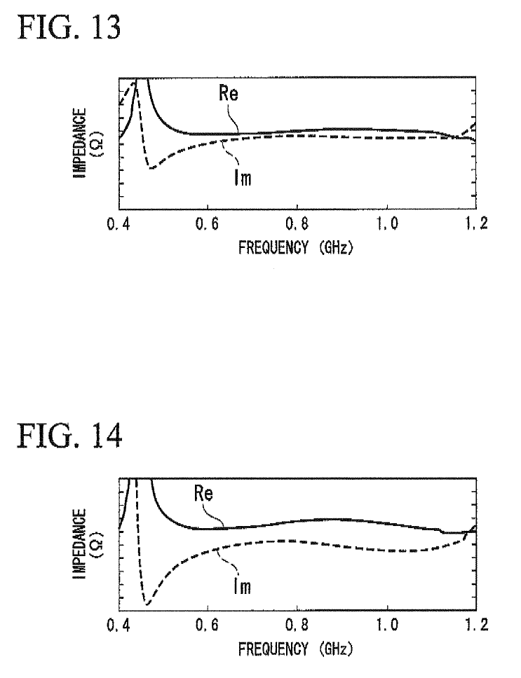

FIG. 9 shows an antenna (type B) 91 in which the upper ends of conductors 93a and 93b corresponding to the left and right conductors 83a and 83b of the antenna (type A) 81 are electrically connected to each other in order to further widen the frequency band of the antenna (type A) 81. FIG. 13 shows the frequency (horizontal axis) characteristics of the input impedance (vertical axis) of the antenna (type B). As shown in FIG. 15, when the upper parts of the conductors 93a and 93b provided on the left and right sides of the feed portion 92 are electrically connected to each other as in the antenna (type B) 91, the number of paths (loops) is increased, and a frequency band having a VSWR (which is represented by a one-dot chain line in FIG. 15) of 2 or less is wider than that of the antenna (type A) 81. Therefore, a sufficient frequency band is obtained for communication between a vehicle and the road, which will be described below.

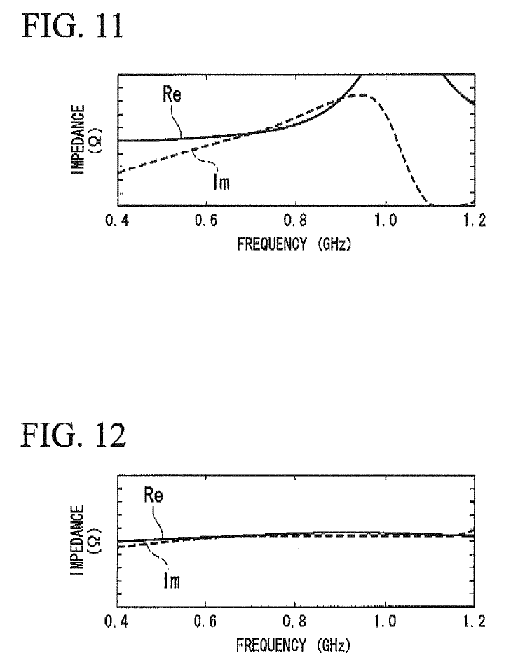

For example, when the antenna (type B) 91 is provided on a glass surface, a feed line (not shown) connected to the feed portion 92 shields the directivity of the antenna 91 since the feed portion 92 is provided at the center of the antenna 91, which may result in deterioration of the directional gain performance of the antenna 91. Therefore, when an antenna, such as the antenna (type B) 91, is provided on the glass surface, it is necessary to provide a feed portion 102 at the lower ends of the left and right conductors 103a and 103b as in an antenna (type C) 101 shown in FIG. 10, in order to prevent the deterioration of the directional gain performance of the antenna. FIG. 14 shows the frequency (horizontal axis) characteristics of the input impedance (vertical axis) of the antenna (type C) 101. As shown in FIG. 15, since the symmetry of the antenna (type C) 101 is lower than that of the antenna (type B) 91, the VSWR of the antenna (type C) 101 (which is represented by a dashed line in FIG. 15) is slightly less than that of the antenna (type B), but the frequency band thereof is sufficiently wider than that of the antenna (type A) 81. Therefore, a sufficient frequency band is obtained for communication between the road and the vehicle or communication between the vehicles, which will be described below.

However, the antenna (type C) 101 provided on the glass surface includes the conductors with a large width. Therefore, when the antenna is provided on the rear glass or the front glass of the vehicle, the antenna obstructs the driver's view or the appearance of the vehicle is adversely affected. Therefore, it is preferable that the conductors of the antenna (type C) 101 be formed in a linear shape.

An in-vehicle antenna 10 according to this embodiment is manufactured using the antenna (type C) 101 as a base. The thickness of the conductor is reduced to the lower limit of manufacture such that the same antenna performance as that of the antenna (type C) 101 is ensured while satisfying conditions, such as the arrangement of the feed portion.

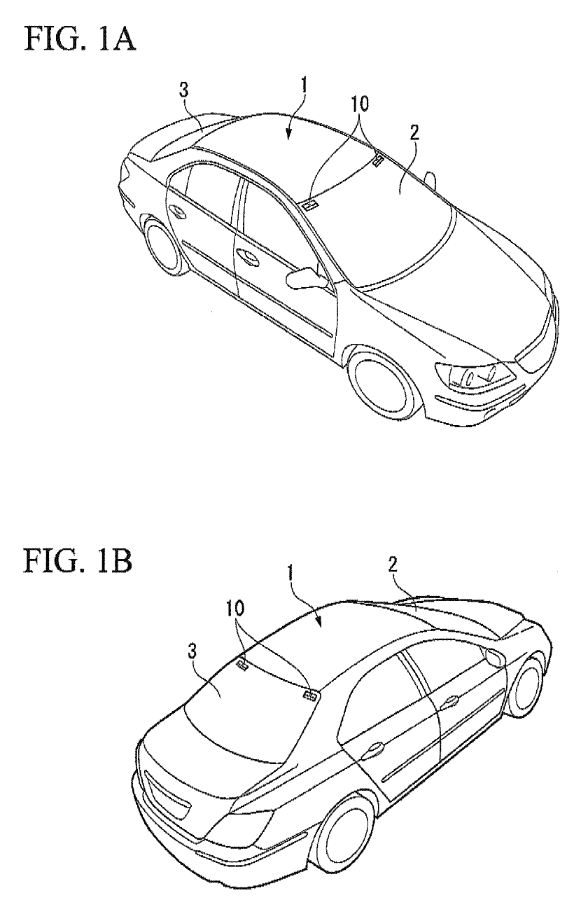

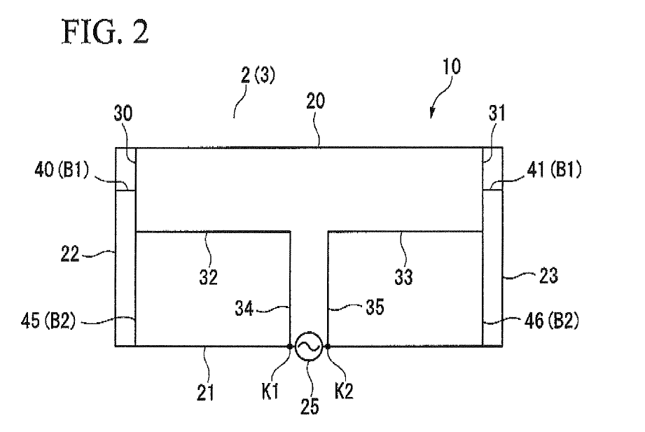

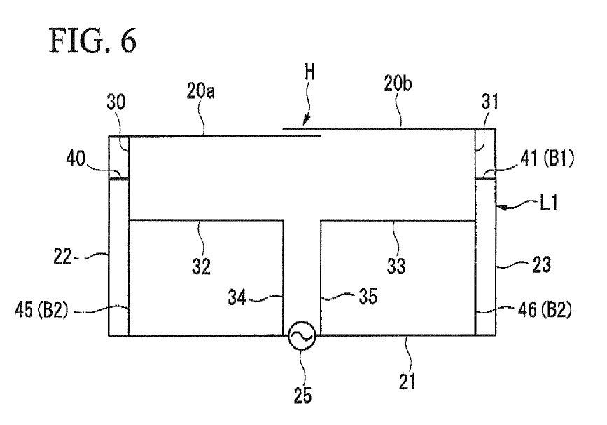

Hereinafter, this embodiment will be described with reference to FIGS. 1A to 5. In FIGS. 2 to 4B, for convenience of illustration, the mounting states shown in FIGS. 1A and 1B are reversed in the vertical direction (which is the same with FIGS. 6, 16, and 19).

For example, as shown in FIGS. 1A and 1B, the in-vehicle antennas 10 according to the first embodiment are provided on the inner surface of the vehicle 1 in the vicinities of the left and right corners of an upper part of a front glass (window glass) 2 of the vehicle 1 and in the vicinities of the left and right corners of an upper part of a rear glass (window glass) 3. The in-vehicle antennas 10 formed on the front glass 2 and the rear glass 3 have the same structure. Therefore, hereinafter, the in-vehicle antenna 10 provided on the front glass 2 will be described as an example.

For example, the in-vehicle antenna 10 is an antenna for mobile combination used for a so-called advanced cruise-assist highway system (AHS) that checks the position or behavior of a vehicle and the neighboring vehicles using information communication, such as communication between the road and the vehicle or communication between the vehicles, in real time and assists safe driving, a navigation system that uses information of a so-called vehicle information and communication system (VICS) that provides road information, such as traffic information, using, for example, electric wave beacons, and an advanced traffic system which is called an ITS (intelligent transport system), such as an electronic toll collection (ETC) system used at an expressway tollgate. In addition, the in-vehicle antenna 10 can be used as an in-vehicle television antenna for receiving digital terrestrial broadcasting waves in a terrestrial UHF (ultrahigh frequency) band. The frequency band of the ITS is set close to the high frequency side (for example, approximately 0.71 to 0.77 GHz) of the UHF band (for example, approximately 0.47 to 0.69 GHz) used in the digital terrestrial broadcasting system.

As shown in FIG. 2, the in-vehicle antenna 10 includes linear conductors fixed to the upper surface of the front glass 2, which is a dielectric body. Specifically, the in-vehicle antenna 10 includes an upper line 20 formed in the width direction, which is the horizontal direction, and a lower line 21 that is formed in parallel to the upper line 20 and has a feed portion 25 for driving the in-vehicle antenna 10 provided substantially at the center in the horizontal direction. A left line 22 that connects the left ends of the upper line 20 and the lower line 21 is provided at the left ends of the upper line 20 and the lower line 21, and a right line 23 that connects the right ends of the upper line 20 and the lower line 21 is provided at the right ends of the upper line 20 and the lower line 21. The left line 22 and the right line 23 are parallel to each other and perpendicularly intersect the upper line 20 and the lower line 21, respectively. The upper and lower lines 20 and 21 and the left and right lines 22 and 23 form a rectangular loop.

The in-vehicle antenna 10 includes a line 30 that extends downward from a position that is disposed slightly inside the left end of the upper line 20 along the left line 22 and reaches substantially the center of the in-vehicle antenna 10 in the vertical direction, a line 32 that is formed so as to extend from the lower end of the line 30 to the inside of the in-vehicle antenna 10 in parallel to the lower line 21, and a line 34 that extends downward from the inner end of the line 32 along the left line 22 and is perpendicularly connected to an intersection point K1 with the lower line 21.

The in-vehicle antenna 10 further includes a line 31 that extends downward from a position that is disposed slightly inside the right end of the upper line 20 along the right line 23 and reaches substantially the center of the in-vehicle antenna 10 in the vertical direction, a line 33 that extends from the lower end of the line 31 to the inside of the in-vehicle antenna 10 in parallel to the lower line 21, and a line 35 that extends downward from the inner end of the line 33 and is perpendicularly connected to an intersection point K2 with the lower line 21. The lines 31, 33, and 35 and the lines 30, 32, and 34 are symmetric with respect to the vertical axis. The line 35 and the line 34 are arranged in parallel to each other, and the feed portion 25 is provided on the lower line 21 between the intersection point K1 between the line 34 and the lower line 21 and the intersection point K2 between the line 35 and the lower line 21. The upper and lower lines 20 and 21 and the lines 30 to 35 form an inner loop (another loop) that shares the upper and lower lines 20 and 21 with the above-mentioned rectangular loop and has a path arranged inside the rectangular loop.

In the in-vehicle antenna 10, first bypasses (bypass units) B1 are provided between the left line 22 and the line 30 and between the right line 23 and the line 31. Specifically, the in vehicle antenna 10 includes a bypass line 40 that is provided substantially at the center of the line 30 in the vertical direction so as to perpendicularly intersect the line 30 and the left line 22 and to connect them via the shortest distance and a bypass line 41 that is provided substantially at the center of the line 31 in the vertical direction so as to perpendicularly intersect the line 31 and the right line 23 and to connect them via the shortest distance. That is, the bypass lines 40 and 41 are symmetric with respect to the vertical axis. A pair of the bypass lines 40 and 41 forms the first bypass B1.

In addition, the in-vehicle antenna 10 includes second bypasses (bypass units) B2 provided between the line 30 and the lower line 21 and between the line 31 and the lower line 21. Specifically, the in-vehicle antenna 10 includes a bypass line 45 that extends from the line 30 downward and is perpendicularly connected to the lower line 21 and a bypass line 46 that extends from the line 31 downward and is perpendicularly connected to the lower line 21. A pair of the bypass lines 45 and 46 forms the second bypass B2. Each of the bypass lines 45 and 46 has a length that is substantially half the length of each of the left and right lines 22 and 23, and the length of each of the bypass lines 45 and 46 is sufficiently larger than that of the first bypass B1. The first bypass B1 and the second bypass B2 are lines that electrically connect a first closed circuit (a rectangular loop portion) L1 and a sixth closed circuit (another loop portion) L6, which will be described below. Therefore, the first bypass B1 and the second bypass B2 are referred to as bypasses.

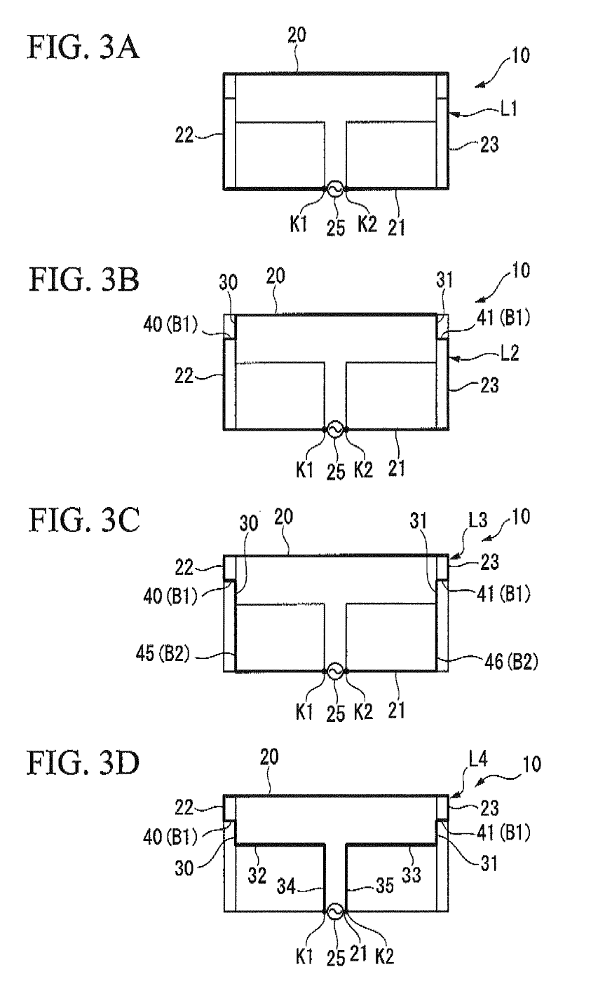

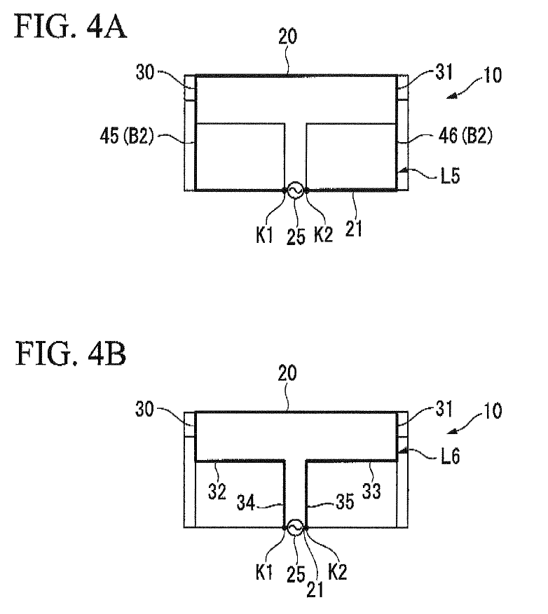

As shown in FIGS. 3A to 4B, since the first bypass B1 and the second bypass B2 are provided in the in-vehicle antenna 10, a plurality of closed circuits (loops) are formed in the in-vehicle antenna 10.

Firstly, FIG. 3A shows the path of the first closed circuit L1 (represented by a bold line), which is the rectangular loop. When the path of the first closed circuit L1 is described in the clockwise direction using the feed portion 25 as a start point, the path of the first closed circuit L1 is a loop passing through the feed portion 25, the lower line 21, the left line 22, the upper line 20, the right line 23, the lower line 21, and the feed portion 25 in this order. The line length of the first closed circuit L1 is larger than those of the fifth and sixth closed circuits, which will be described below.

FIG. 3B shows the second closed circuit L2. When the path of the second closed circuit L2 is described in the clockwise direction using the feed portion 25 as a start point, the path of the second closed circuit L2 is a loop passing through the feed portion 25, the lower line 21, the left line 22, the bypass line 40 forming the first bypass B1, the line 30, the upper line 20, the line 31, the bypass line 41 forming the first bypass B1, the right line 23, the lower line 21 and the feed portion 25 in this order. The line length of the second closed circuit L2 is equal to that of the first closed circuit L1, but the upper path of the second closed circuit L2 corresponding to the first bypass B1 is inside by more than that of the first closed circuit L1.

FIG. 3C shows a third closed circuit L3. When the path of the third closed circuit L3 is described in the clockwise direction using the feed portion 25 as a start point, the path of the third closed circuit L3 is a loop passing through the feed portion 25, the lower line 21, the bypass line 45 forming the second bypass B2, the line 30, the bypass line 40 forming the first bypass B1, the left line 22, the upper line 20, the right line 23, the bypass line 41 forming the first bypass B1, the line 31, the bypass line 46 forming the second bypass 32, the lower line 21, and the feed portion 25 in this order. The line length of the third closed circuit L3 is equal to those of the first closed circuit L1 and the second closed circuit L2. However, since the third closed circuit L3 includes the paths extending from the left and right lines 22 and 23 to the second bypass B2 through the first bypass B1, the left and right lines in a lower part of the third closed circuit L3 are inside by more than the left and right lines 22 and 23 of the first closed circuit L1.

FIG. 3D shows a fourth closed circuit L4. When the path of the fourth closed circuit L4 is described, in the clockwise direction using the feed portion 25 as a start point, the path of the fourth closed circuit L4 is a loop passing through the feed portion 25, the lower line 21, the line 34, the line 32, the line 30, the bypass line 40 forming the first bypass B1, the left line 22, the upper line 20, the right line 23, the bypass line 41 forming the first bypass B1, the line 31, the line 33, the line 3S, the lower line 21, and the feed portion 25 in this order. The line length of the fourth closed circuit L4 is equal to those of the first to third closed circuits, but the lower path of the fourth closed circuit L4 is inside by more than that of the third closed circuit L3.

That is, the first to fourth closed circuits L4 have the same line length and different paths.

FIG. 4A shows the fifth closed circuit L5 having a line length smaller than those of the first to fourth closed circuits L1 to L4 in the in-vehicle antenna 10. When the path of the fifth closed circuit L5 is described in the clockwise direction using the feed portion 25 as a start point, the path of the fifth closed circuit L5 is a loop passing through the feed portion 25, the lower line 21, the bypass line 45 forming the second bypass B2, the line 30, the upper line 20, the line 31, the bypass line 46 forming the second bypass B2, the lower line 21, and the feed portion 25 in this order. The left and right paths of the fifth closed circuit L5 are inside by more than those of the first closed circuit L1, and the line length of the fifth closed circuit L5 is reduced by a value corresponding thereto.

FIG. 4B shows the sixth closed circuit L6, which is the above-mentioned inner loop (another loop). When the path of the sixth closed circuit L6 is described in the clockwise direction using the feed portion 25 as a start point, the path of the sixth closed circuit L6 is a loop passing through the feed portion 25, the lower line 21, the line 34, the line 32, the line 30, the upper line 20, the line 31, the line 33, the line 35, the lower line 21, and the feed portion 25 in this order. That is, the line length of the sixth closed circuit L6 is equal to that of the fifth closed circuit L5, but the lower path of the sixth closed circuit L6 is inside by more than that of the fifth closed circuit L5.

In the in-vehicle antenna 10 according to this embodiment, the above-mentioned closed circuits are mainly classified into two groups according to the line lengths. When a relatively low frequency is received, the first to fourth closed circuits L1 to L4 having long line lengths are used. As such, since a plurality of paths that receive radio waves in a low frequency band are formed, one of the first to fourth closed circuits L1 to L4 having optimal input impedance is appropriately used. As a result, it is possible to widen the low frequency band. Similarly, when a relatively high frequency is received, the fifth and sixth closed circuits L5 and L6 having long line lengths are used. Since a plurality of paths are also formed in the high frequency band, one of the fifth and sixth closed circuits L5 and L6 having optimal input impedance is appropriately used. As a result, it is possible to widen the high frequency band.

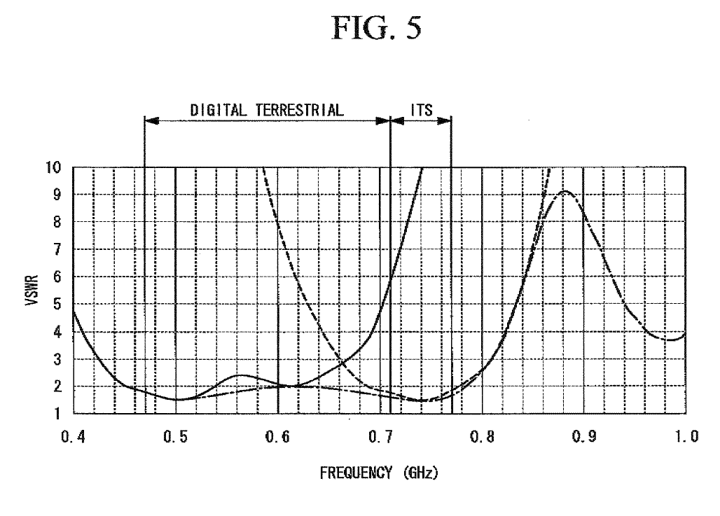

FIG. 5 shows a variation in VSWR (vertical axis) with respect to the frequency (horizontal axis)[GHz] when the in-vehicle antenna 10 has predetermined outer dimensions (for example, the left and right lines 22 and 23 are approximately 80 mm and the upper and lower lines 20 and 21 are approximately 160 mm). In FIG. 5, an overlapping waveform, among the waveforms indicating the variation in VSWR by the first to fourth closed circuits L1 to L4, is a low-frequency-side waveform (which is represented by a solid line in FIG. 5) and an overlapping waveform between the waveforms indicating the variation in VSWR by the fifth and sixth closed circuits L5 and L6 is a high-frequency-side waveform (which is represented by a dashed line in FIG. 5). When the waveforms of the first to sixth closed circuits overlap each other, a waveform represented by a one-dot chain line in FIG. 5 is obtained. The waveform represented by the one-dot chain line overlaps the waveform represented by the solid line in FIG. 5 at a low frequency side, and overlaps the waveform represented by the dashed line in FIG. 5 at a high frequency side. In the overlapping waveform, which is represented by the one-dot chain line, among the waveforms of the first to sixth closed circuits, a frequency having a VSWR of 2 or less is in the range of 0.45 to 0.79 GHz, the bandwidth thereof is 0.34 GHz, and the VSWR of the frequency used for the digital terrestrial broadcasting system (which is described in FIG. 5 as ‘digital terrestrial’) and ITS closer to the high frequency side than the digital terrestrial broadcasting system is less than or equal to 2.

Therefore, according to the first embodiment, the first bypass B1 and the second bypass B2 that connect the first closed circuit L1 and the sixth closed circuit L6 are provided in portions that are not shared by the path of the first closed circuit L1 and the path of the sixth closed circuit L6 farmed inside the first closed circuit L1. Therefore, the second to fifth closed circuits having different paths are formed to widen a frequency band having a VSWR of 2 or less to approximately 0.45 to 0.79 GHz. As a result, it is possible to achieve an antenna having a sufficient performance for ITS or the digital terrestrial broadcasting system without obstructing a driver' view and adversely affecting the outward appearance of a vehicle.

The first bypass B1 and the second bypass B2 make it possible to use various paths, as compared to the structure in which one of the first and second bypasses is provided. Therefore, it is possible to further widen a frequency band.

The invention is not limited to the above described first embodiment, but the lengths or the connection positions of the first bypass B1 and the second bypass B2 may be changed depending on desired frequency characteristics.

As a modification of the first embodiment for example, as shown in FIG. 6, a portion of the upper line 20 of the first closed circuit L1 may be physically cut into upper lines 20a and 20b, and a parallel section H in which the right and left ends of the upper lines 20a and 20b close to the center are parallel to each other with a predetermined gap therebetween may be provided. In this case, even when a closed circuit is not physically formed, the lines are electrostatically coupled to each other in the parallel section H, particularly, in the high frequency band transmitted or received by the in-vehicle antenna 10. Therefore, the first closed circuit L1 forms a closed circuit having a capacitor connected in series thereto in an equivalent circuit. As a result, it is possible to obtain the same frequency characteristics as those of the in-vehicle antenna 10 according to the first embodiment. That is, in the first embodiment, the first to sixth closed circuits may be formed as electrically closed circuits, but they are not limited to physically connected closed circuits.

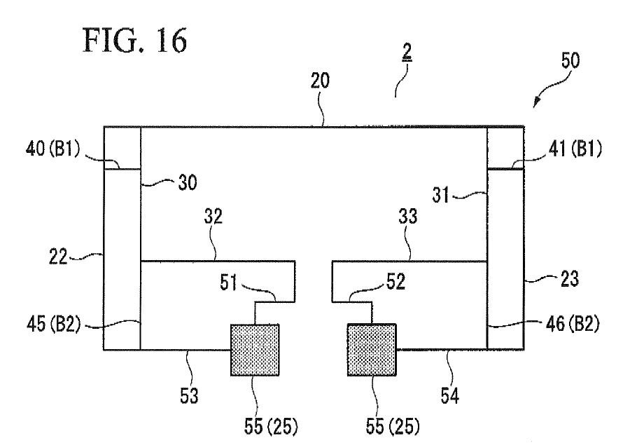

Next, a second embodiment of the invention will be described with reference to FIG. 16. The structure of an in-vehicle antenna according to the second embodiment is similar to that according to the first embodiment except for the structure of a feed portion. Therefore, in the following description, the same components as those in the first embodiment are denoted by the same reference numerals.

As shown in FIG. 16, an in-vehicle antenna 50 according to this embodiment mainly includes linear conductors fixed to the upper surface of a front glass 2, which is a dielectric body, similar to the first embodiment.

Specifically, the in-vehicle antenna 50 includes an upper line 20 formed in the width direction, which is the horizontal direction, and left and right lines 22 and 23 that are substantially perpendicular to the upper line 20 and are connected to the left and right ends of the upper line 20, respectively.

In addition, the in-vehicle antenna 50 includes a line 30 that extends downward from a position that is disposed slightly inside the left end of the upper line 20 along the left line 22 and reaches substantially the center of the in-vehicle antenna 50 in the vertical direction, a line 32 that extends from the lower end of the line 30 to the inside of the in-vehicle antenna 10, and a line 51 that extends downward from the inner end of the line 32 along the left line 22 and is bent to the line 22 in a crank shape.

In addition, in the bilateral symmetric position of the line 30, 32, and 51, the in-vehicle antenna 50 includes a line 31 that extends downward from a position that is disposed slightly inside the right end of the upper line 20 along the right line 23 and reaches substantially the center of the in-vehicle antenna 50 in the vertical direction, a line 33 that extends from the lower end of the line 31 to the inside of the in-vehicle antenna 50, and a line 52 that extends downward from the inner end of the line 33 and is bent to the right line 23 in a crank shape.

The in-vehicle antenna 50 further includes a lower left line 53 that extends inward from the lower end of the left line 22 and a lower right line 54 that extends inward from the lower end of the right line 23.

Similar to the first embodiment, a first bypass (bypass unit) B1 including a bypass line 40 is formed between the left line 22 and the line 30 and a first bypass (bypass unit) B1 including a bypass line 41 is formed between the right line 23 and the line 31. In addition, a second bypass (bypass unit) B2 including a bypass line 45 is formed between the line 30 and the lower left line 53, and a second bypass (bypass unit) B2 including a bypass line 46 is formed between the line 31 and the lower right line 54.

Furthermore, in the in-vehicle antenna 50, feed surfaces 55 are provided at a connection point between the line 51 and the lower left line 53 and a connection point between the line 52 and the lower right line 54. Each of the feed surfaces 55 is used for connection to an amplifier module M (which will be described below) that supplies power to the in-vehicle antenna 50, and is formed of a metal plate or a metal foil film having a substantially rectangular shape. The feed surfaces 55 form the feed portion 25.

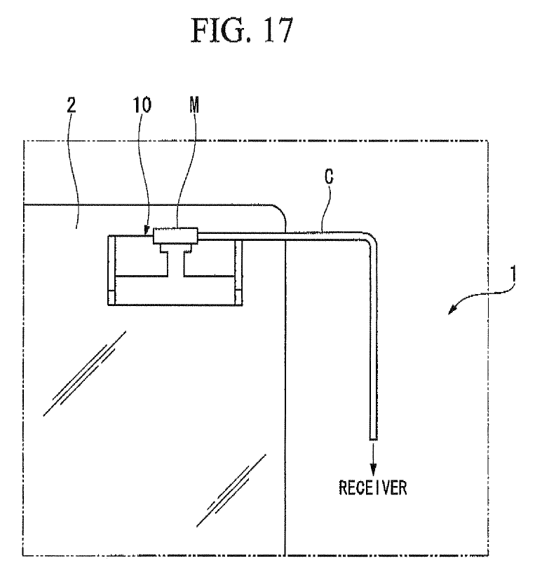

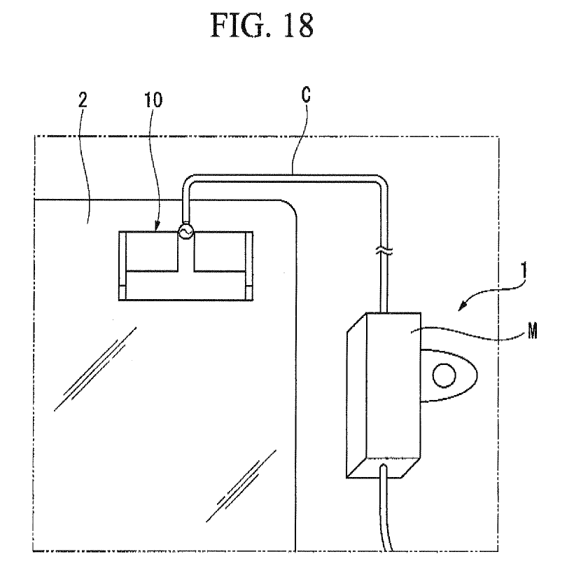

Therefore, according to this embodiment, when the in-vehicle antenna 10 provided on the front glass 2 is connected to the amplifier module M by a coaxial cable C (for example, see FIG. 18), any of the following problems may arise: the efficiency of the antenna is lowered due to impedance mismatching between the in-vehicle antenna 10 and the coaxial cable C; an electromagnetic wave radiated by the coaxial cable C causes the antenna to lose power or the distortion of the directionality of the antenna; the shielding performance of the coaxial cable is lowered and the antenna is likely to be affected by ambient noise; antenna characteristics vary due to the shaking of the coaxial cable C caused by vibration or a difference in the layout of the coaxial cable C; and the antenna performance is lowered due to the disturbance of the coaxial cable C or the lowering of the noise figure caused by the disturbance of the coaxial cable. As shown in FIG. 17, when the amplifier module M is directly connected to the feed surfaces 55 of the in-vehicle antenna 50 without the coaxial cable C interposed therebetween, it is possible to solve the above-mentioned problems and improve and stabilize the antenna performance.

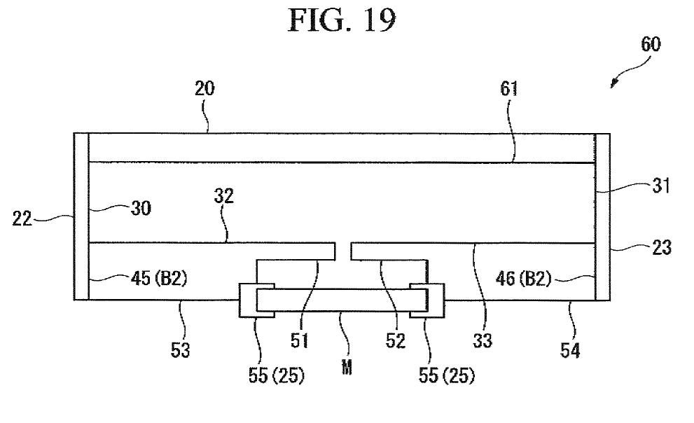

Next, a third embodiment of the invention will be described with reference to FIG. 19. In an in-vehicle antenna according to the third embodiment, instead of the first bypass B1 according to the second embodiment, an upper parallel line is provided inside an inner loop (another loop) formed by a line 51, a line 32, a line 30, an upper line 20, a line 31, a line 33, and a line 52. In the following description, the same components as those of the in-vehicle antenna according to the second embodiment are denoted by the same reference numerals.

As shown in FIG. 19, an in-vehicle antenna 60 according to this embodiment mainly includes linear conductors fixed to the upper surface of a front glass 2, which is a dielectric body, similar to the in-vehicle antenna 10 of the first embodiment and the in-vehicle antenna 50 of the second embodiment.

Specifically, the in-vehicle antenna 60 includes an upper line 20 formed in the width direction, which is the horizontal direction, and left and right lines 22 and 23 that are substantially perpendicular to the upper line 20 are connected to the left and right ends of the upper line 20, respectively.

In addition, the in-vehicle antenna 60 includes a line 30 that extends downward from a position that is disposed slightly inside the left end of the upper line 20 along the left line 22 and reaches substantially the center of the in-vehicle antenna 60 in the vertical direction, a line 32 that extends from the lower end of the line 30 to the inside of the in-vehicle antenna 10, and a line 51 that extends downward from the inner end of the line 32 along the left line 22 and is bent to the line 22 in a crank shape.

In addition, in the bilateral symmetric position of the line 30, 32, and 51, the in-vehicle antenna 60 includes a line 31 that extends downward from a position that is disposed slightly inside the right end of the upper line 20 along the right line 23 and reaches substantially the center of the in-vehicle antenna 60 in the vertical direction, a line 33 that extends from the lower end of the line 31 to the inside of the in-vehicle antenna 60, and a line 52 that extends downward from the inner end of the line 33 and is bent to the right line 23 in a crank shape. The above-described lines 32 and 51 constitute the seventh line, and the lines 33 and 52 constitute the eighth line.

The in-vehicle antenna 60 further includes a lower left line 53 that extends inward from the lower end of the left line 22 and a lower right line 54 that extends inward from the lower end of the right line 23.

The in-vehicle antenna 60 further includes an upper parallel line 61 that is provided inside an inner loop (another loop) formed by the line 51, the line 32, the line 30, the upper line 20, the line 31, the line 33, and the line 52 and is parallel to the upper line 20. The right end of the upper parallel line 61 is connected to the line 31 at a position that is slightly below a connection portion between the upper line 20 and the line 31, and the left end of the upper parallel line 61 is connected to the line 30 at a position that is slightly below a connection portion between the upper line 20 and the line 30.

Similar to the first and second embodiments, a second bypass (bypass unit) B2 including a bypass line 45 is formed between the line 30 and the lower left line 53, and a second bypass (bypass unit) B2 including a bypass line 46 is formed between the line 31 and the lower right line 54. The line 45 and the line 30 form a fifth line, and the line 46 and the line 31 form a sixth line.

Similar to the second embodiment, in the in-vehicle antenna 60, feed surfaces 55 are provided at a connection point between the line 51 and the lower left line 53 and a connection point between the line 52 and the lower right line 54. Each of the feed surfaces 55 is used for connection to an amplifier module M that supplies power to the in-vehicle antenna 60, and is formed of a metal plate or a metal foil film having a substantially rectangular shape. The feed surfaces 55 form the feed portion 25. The amplifier module M is connected between the feed surfaces 55.

In the in-vehicle antenna 60, since the amplifier module M is connected between the feed surfaces 55 forming the feed portion 25, the distance between the feed surfaces 55 is relatively long. The VSWR characteristics of the in-vehicle antenna 60 tend to be lowered as the distance between the feed surfaces 55 is increased.

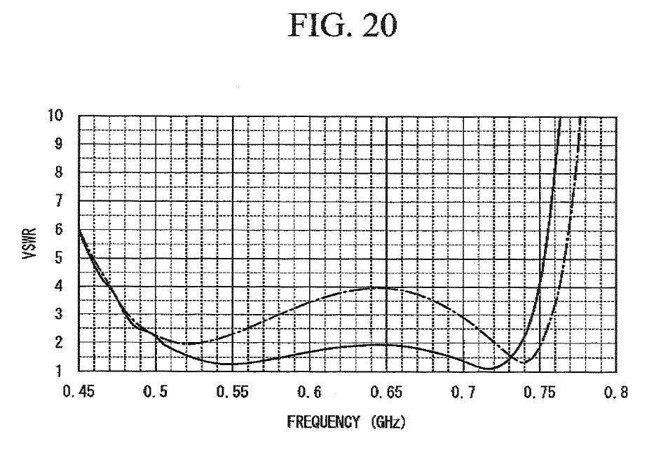

FIG. 20 shows a variation in VSWR (vertical axis) with respect to the frequency (horizontal axis)[GHz] when the in-vehicle antenna 60 has predetermined outer dimensions (for example, the left and right lines 22 and 23 are approximately 30 mm and the upper and lower lines 20 and 21 are approximately 160 mm). In FIG. 20, a frequency at which the VSWR of the in-vehicle antenna 60 is 2 or less is in the range of approximately 0.50 to 0.74 GHz, and the bandwidth thereof is 0.24 GHz. In FIG. 20, the waveform represented by a one-dot chain line indicates the VSWR of an in-vehicle antenna (not shown) according to a comparative example in which the upper parallel line 61 of the in-vehicle antenna 60 is not provided. The VSWR is 2 or less in a portion of the lower frequency band and a portion of the high frequency band, which are very narrow frequency bands. In the in-vehicle antenna without the upper parallel line 61 according to the comparative example, the distance between the feed surfaces 55 of the in-vehicle antenna 60 is relatively long, similar to the in-vehicle antenna 60.

Therefore, according to the third embodiment, the upper parallel line 61 is formed inside the inner loop. Therefore, particularly, in the in-vehicle antenna 60 having a long distance between the feed surfaces 55, it is possible to widen the frequency band in which the VSWR is 2 or less, as compared to the in-vehicle antenna without the upper parallel line 61. As a result, it is possible to improve the VSWR characteristics and ensure good antenna characteristics over the entire frequency band.

In the above-described third embodiment, the upper parallel line (bypass unit) 61 and the second bypass B2 are provided in the in-vehicle antenna 60, which is a rectangular loop antenna, but the invention is not limited to the structure of the third embodiment. For example, the first bypass B1, that is, the lines 40 and 41 of the in-vehicle antennas 10 and 50 according to the first and second embodiments may be provided in the in-vehicle antenna 60 according to the third embodiment.

According to the invention, it is possible to provide a rectangular loop antenna having an antenna structure capable of widening a frequency band with high reception efficiency, without adversely affecting the outward appearance.

1. An antenna structure of a rectangular loop antenna that is provided on a window glass of a vehicle, comprising:
a loop portion that is provided inside a rectangular loop portion of the rectangular loop antenna and has a path partially shared with the rectangular loop portion; and
a bypass unit that connects the path of the another loop portion and the path of the rectangular loop portion which is not shared with the path of the loop portion.

2. The antenna structure of a rectangular loop antenna according to claim 1, wherein
at least two pairs of the bypass units are provided.

3. The antenna structure of a rectangular loop antenna according to claim 1, wherein
the rectangular loop portion has a feed portion on a loop line thereof.

4. The antenna structure of a rectangular loop antenna according to claim 1, wherein the rectangular loop portion has an electrostatic coupling portion electrostatically coupled to a portion of a loop line thereof.

5. The antenna structure of a rectangular loop antenna according to claim 1, further comprising:
a bypass unit that connects portions of the path of the loop portion that are not shared with the path of the rectangular loop portion is provided inside the loop portion.

6. An antenna structure of a rectangular loop antenna that is provided on a window glass of a vehicle, comprising:
a first line that has a feed portion at the center thereof;
a second line that is opposite to the first line;
a rectangular loop portion that is formed by third and fourth lines connecting the ends of the first and second lines;
fifth and sixth lines that are provided inside the rectangular loop portion, are parallel to the third and fourth lines, and are connected to the first and second lines, respectively;
a seventh line that connects the feed portion or the first line in the vicinity of the feed portion and the fifth line; and
an eighth line that connects the first line and the sixth line.

7. The antenna structure of a rectangular loop antenna according to claim 6, further comprising:
a ninth line that connects the third line and the fifth line; and
a tenth line that connects the fourth line and the sixth line.

8. The antenna structure of a rectangular loop antenna according to claim 6, further comprising:
an eleventh line that is parallel to the second line and connects the fifth line and the sixth line.
